(19) United States
(12) Patent Application Publication
(10) Pub. No.: US 2019/0208716 A1
(43) Pub. Date: Jul. 11, 2019

(54) FIXED SUPPORT FOR ANTI-TOPPLING FROST PREVENTION MACHINE

(71) Applicant: JiangSu University, Jiangsu (CN)

(72) Inventors: Lili DONG, Jiangsu (CN); Quan Bu, Jiangsu (CN)

(73) Assignee: JiangSu University, Jiangsu (CN)

(21) Appl. No.: 16/099,434

(22) PCT Filed: Apr. 21, 2017
(86) PCT No.: PCT/CN2017/081391

§ 371 Date: Nov. 7, 2018

(30) Foreign Application Priority Data
May 9, 2016 (CN) 201610300818.4

(51) Int. Cl. A01G 13/08; F16M 11/22

(52) U.S. Cl. CPC A01G 13/08; F16M 2200/08; F16M 11/22

(57) ABSTRACT

A fixed support for an anti-toppling frost prevention machine includes a frost prevention machine, a connection support, an anti-toppling reinforcement seat, a base bolt, and a base seat. The connection support includes an anti-toppling guide cylinder, a fixed supporting column, and a connecting plate. The anti-toppling reinforcement seat is formed by fixing a reinforcement seat bracket and an anti-toppling supporting foot through a bolt. The base seat is formed by fixing a base plate through an upper connection ring, and a lower connection ring. The base bolt is used for fixing the connection support and the base seat.

### BACKGROUND

### Technical Field

The present invention relates to a device of fixed support for an anti-toppling frost prevention machine, which specifically relates to a fixed device and method of a column of the frost prevention machine used in tea (fruit) garden, which belongs to the technical field of agricultural machinery.

### Background Art

China has a long history of tea tree planting and drinking. The growth and development of tea trees requires a warm and humid climate. The germination of tea buds in early spring is easy to be affected by cold spell in later spring, which reduces quality and production of the tea. In recent years, research on tea tree defrosting technology has been carried out rapidly in China. The research shows that frost prevention effect can be achieved by using the frosting prevention machine to conduct airflow disturbance from top to bottom.

At present, commonly used methods for fixing the frost prevention machine columns are as below. (1) Digging a pit with a certain depth in a location where the frost prevention machine is installed in a manual way. Pouring concrete in the pit, and a top of the concrete is provided with an anchor bolt. A column bottom flange is fixed on a foundation of the concrete by the anchor bolt. The disadvantage of this method is that labor intensity is high and installation efficiency of the frosting prevention machine is low. (2) Use tools to dig a pit with a certain depth and a diameter slightly larger than a diameter of the column in the location where the frost prevention machine is installed. The column is placed in the pit with a body of the column being kept upright, and is buried via filling of soil or concrete after adjusting the direction. The disadvantage of this method is that: in order to guarantee working requirement of the column, the pit can only has the diameter slightly larger than that of the column, such that in late burying, a gap between soil and column is hard to eliminate. The gap will further increase due to vibration and wind generated from frost prevention machine in the process of using machine, this severely reduces safety of using the frost prevention machine and work efficiency. To solve the problem of high labor intensity and low efficiency of digging the pit, the present invention provides the base plate punched in the soil to replace the deep pit fixing frost prevention machine, which greatly reduces the labor intensity and improves the installation efficiency of the frost prevention machine. In addition, Chinese utility model patent CN201120394200.1 discloses a fixing device for a stand column of a frost prevention machine, which includes several root stand mechanisms disposed at a bottom of the stand column. The root stand mechanisms include a steel root beam formed by a metal sheet beam transversely bent into trough type, and a U-shaped hoop. A pair of positioning rods is disposed on a middle of the steel root beam. A lower part of the column is positioned between a bunch of positioning rods, which are fixed vertically to the steel root beam through the U-shaped hoop. This method requires digging bigger and deeper pits, which increase the labor intensity, and requirement of installation of the device itself is high and cost is relatively high. The common feature of the above method is that it is necessary to dig a small diameter and high precision deep pit in the installation position of frost prevention machine, and it is labor intensive, time consuming and costly. The present invention adopts method of driving the base plate to insert into the soil to avoid the work of digging pits, thus it reduces the labor intensity, and improves the installation efficiency of the frost prevention column. The height of the frost prevention machine to the ground needs to reach 6.7 meters to meet the frost prevention effect of the frost prevention machine. Non-standard pipe is adopted in the conventional frost prevention machine column since the standard length of the pipe is 6 meters, which has a high cost. The use of the connecting support provided by the present invention can make the frost prevention machine column adopt standard pipe material, which can save 50% of the fabricating cost.

### SUMMARY OF THE INVENTION

The purpose of the present invention is to provide a fixing device of a column of a frost prevention machine and its usage method, which has a simple structure and is convenient in installation, so as to reduce labor intensity and installation time of the installation process of the frost prevention machine, and effectively prevent rotation and tilt of the frost prevention machine column, thereby saving material cost and improving economic efficiency.

The technical solutions of the present invention are as follows. A fixed support of an anti-toppling frost prevention machine includes a frost prevention machine 1, a connection support 2, an anti-toppling reinforcement seat 3, a base bolt 4, and a base seat 5. The connection support 2 includes an anti-toppling guide cylinder 21, a fixed supporting column 22, and a connecting plate 23. An outer diameter of the anti-toppling guide cylinder 21 is 0.5-1 mm smaller than an inner diameter of the fixed supporting column 22 and an inner diameter of the frost prevention machine column 11. Two ends of the anti-tilting guide cylinder 21 are provided with chamfers to facilitate the installation of the anti-tilting guide cylinder 21 and the frost prevention machine 1. The frost prevention machine 1 is installed on an upper end of the connection support 2, and a lower end of the frost prevention machine column 11 is provided with small holes for plug welding of the anti-tilting guide cylinder 21 of the connecting support 2. The anti-toppling guide cylinder 21 is installed into the fixed supporting column 22 and the frost prevention machine column 11 with lengths that are respectively more than 200 mm, and is fixed via plug welding to enhance its anti-dumping ability. An outer diameter of the fixed supporting column 22 is equal to an outer diameter of the frost prevention machine column 11. An upper end of the fixed supporting column 22 is provided with small holes for plug welding. An outer end of the connecting plates 23 is provided with four notches for mounting the base bolt 4, and the base bolt 4 is used to connect the connection support 2 and the base seat 5. The anti-toppling reinforcement seat 3 is formed by fixing a reinforcement seat bracket 31 and an anti-toppling supporting feet 32 through bolts. The base seat 5 is formed by fixing a base plate 51 through an upper connecting ring 52 and a lower connecting ring 53. During the assembly, the anti-toppling guide cylinder 21 is first placed around 200 mm above the upper end of the fixed supporting column 22. The anti-toppling guide cylinder 21 and the fixed supporting column 22 are fixed by plug welding. The fixed supporting column 22 is welded vertically in a center of the connecting plates 23. When installing the base seat 5, dig a shallow pit in the corresponding position. Each base plate 51 is punched into the soil 20-30 mm successively after location of each base plate 51 is determined. When the hole used for assembling of the upper connecting ring 52 and the lower connecting ring 53 is close to the ground, the upper connecting ring 52 and the lower connecting ring 53 will engage the hole of each base plate 51 to fix each base plate 51. Then, continue to punch the base plate 51 until the hole on an edge of the base plate for assembling of the base bolt 4 is close to the ground, and the installation of the base seat 5 is completed. Afterwards, the connection support 2 is fixed on the base seat 5 by using the base bolt 4 in a symmetrical installation. After the installation of the connection support 2 is completed, the reinforcement seat bracket 31 is put on the fixed supporting column 22, the anti-toppling supporting feet 32 is punched into the soil through according to position of each plate on the reinforcement seat bracket 31, and the anti-toppling supporting feet 32 is fixed on the reinforcement seat bracket 31 through the bolt. Finally, the frost prevention machine column 11 is put on the anti-tilting guide cylinder 21, and the anti-tilting guide cylinder 21 and the frost prevention machine column 11 are fixed by plug welding.

Preferably, a cross-section of the base seat 5 is cross-shaped.

Preferably, number of the upper connecting ring 52 and that of the lower connecting ring 53 are 1.

Preferably, the fixing methods between the anti-toppling guide cylinder 21 and the fixed supporting column 22, the anti-toppling guide cylinder 21 and the frost prevention machine column 11 are plug welding.

Preferably, number of the anti-toppling supporting feet 32 is 4.

The present invention has simple structure and is convenient in installation, which not only reduces the labor intensity, raise the anti-torsion ability and anti-dumping ability, but also increases the working reliability of frost prevention machine. The use of the connection support enables the standard pipe to replace the non-standard pipe material, which was originally used to meet the height of the frost prevention machine, thereby saving nearly 50% of the cost, and facilitating transportation and storage. At the same time, the installation efficiency and economic benefits of the frost prevention machine are improved.

### BRIEF DESCRIPTION OF THE DRAWINGS

FIG. 1 is a schematic overall installation structure view of a frost prevention machine according to the present invention.

FIG. 2 is a schematic structure view of the frost prevention machine according to the present invention.

FIG. 3 is a schematic installation structure view of a connection support, an anti-toppling reinforcement seat, and a base seat according to the present invention.

FIG. 4 is a schematic structure view of the connection support according to the present invention.

FIG. 5 is a schematic structure view of the anti-toppling reinforcement seat according to the present invention.

FIG. 6 is a schematic structure view of the base seat according to the present invention.

FIG. 7 is a schematic structure view of a base bolt according to the present invention.

### DETAILED DESCRIPTION OF THE EMBODIMENTS

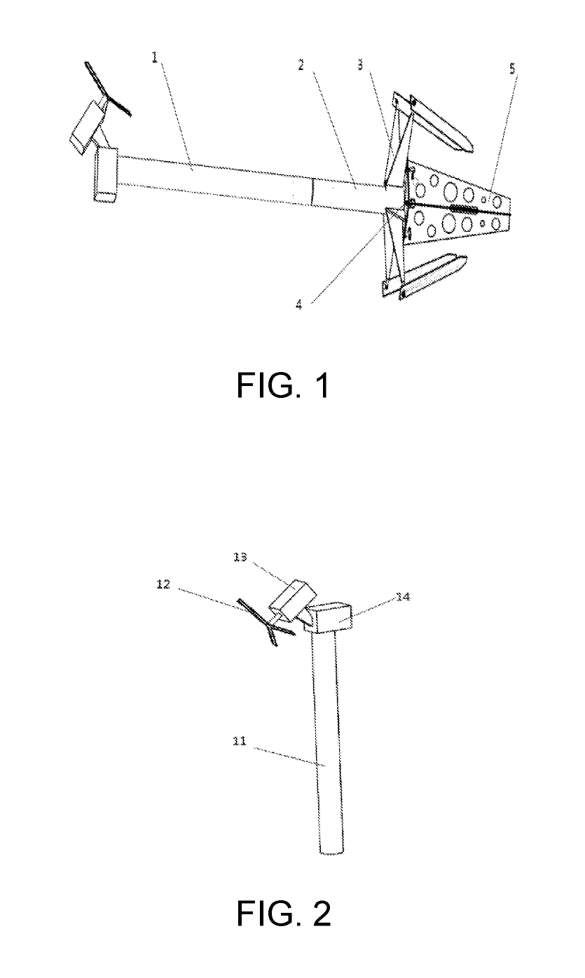

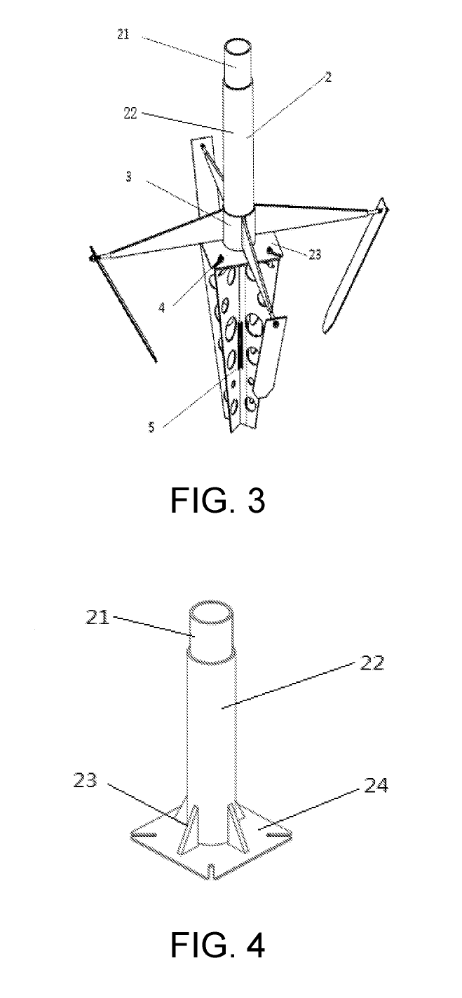

Referring to FIG. 1, the present invention adopts: a frost prevention machine 1, a connection support 2, an anti-toppling reinforcement seat 3, a base bolt 4, and a base 5, such components are combined for installation to meet height requirement and reliability requirement of the frost prevention machine. The frost prevention machine 1 is mounted on the anti-tilting guide cylinder 21 of the connection support 2 by the frost prevention machine column 11. The frost prevention machine 1 is fixed to the connection support 2 by plug welding. The connection support 2 and the base seat 5 are fixed by the base bolts 4.

Referring to FIG. 2, the frost prevention machine includes the frost prevention machine column 11, a frost prevention machine blade 12, a frost prevention machine motor 13, and a frost prevention machine connecting part 14. The frost prevention machine column 11 is a standard pipe with a length that is 6 m.

Referring to FIG. 4, the connecting support 2 includes an anti-toppling guide cylinder 21, a fixed supporting column 22, and a connecting plate 23. An outer diameter of the anti-toppling guide cylinder 21 is 0.5 mm-1 mm smaller than an inner diameter of the fixed supporting column 22. An upper end of the fixed supporting column 22 has three groups of small holes. Firstly, the anti-tilting guide cylinder 21 is placed around 200 mm above the upper end of the fixed supporting column 22, the anti-toppling guide cylinder 21 and the fixed supporting column 22 are fixed by the method of plug welding. Then, the fixed supporting column 22 is welded vertically in a center of the connecting plate 23, and a four-claw fixing sleeve is installed at a bottom of the connection support to enhance the anti-dumping ability of the fixed supporting column 22.

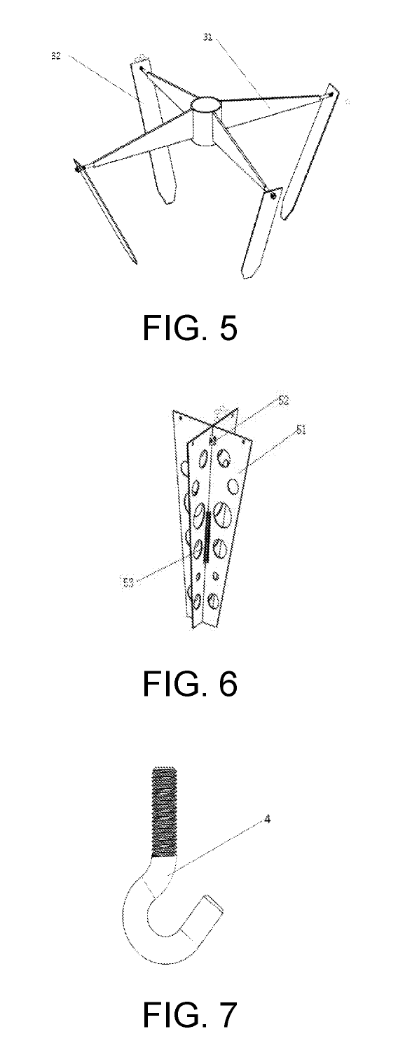

Referring to FIG. 5, the anti-toppling reinforcement seat 3 is formed by fixing a reinforcement seat bracket 31 and anti-toppling supporting feet 32 by bolts. Outer ends of four plates constituting the reinforcement seat bracket 31 have bolt holes for fixing the anti-toppling supporting feet 32, and the four plates are fixed to a section of the pipe. An inner diameter of the pipe constituting the reinforcement seat bracket 31 is 0.5 mm-1 mm large than the outer diameter of the fixed supporting column 22. The anti-toppling supporting feet 32 penetrate the soil in order to enhance the anti-dumping performance of device.

Referring to FIG. 6, the base seat 5 is formed by fixing a base plate 51 through an upper connecting ring 52 and a lower connecting ring 53.

Referring to FIG. 7, the base bolt 4 is used for fixing the connection support 2 and the base seat 5.

Specific Implementation Methods:

The structure, functionality, and processing of the present invention are further described below with reference to the accompanying drawings and the concrete implementation examples. However, claimed scope of this present invention includes but not limited to that.

A fixed support for an anti-toppling frost prevention machine according to the present invention can overcome the difficulties of the high precision of digging aperture, deep pit with a small diameter and the backfill compaction in the commonly used fixed installation methods of the frost prevention machine by punching the base seat into the soil, and reduces the labor intensity and improves installation efficiency. The use of connection support enables the standard pipe material to replace the conventional non-standard pipe material, which was used to meet the height of the frost prevention machine, thereby greatly saving the fabricating cost, and facilitating transportation and storage. The hole in the base plate can integrate the soil inside and outside of the base seat into one piece, which enhances the stability of the base seat and reduces the damage to the soil. The present invention provides a device adapted for fixing a frost prevention machine column, and can also suitable for use in pebbled land.

During assembly of the frost prevention machine, firstly, dig a shallow pit in a corresponding installation position, each of the base plates 51 is recycled to be punched into the soil with 20 mm-30 mm successively after locations of each of the base plates 51 are determined. When the hole used for assembling of the upper connecting ring 52 and the lower connecting ring 53 is close to the ground, the upper connecting ring 52 and the lower connecting ring 53 engage the hole of each of the base plates 51 to fix each of the base plates 51. Secondly, continue to punch the base plate 51 until the hole on an edge of the base plate for assembling of the base bolt 4 is close to the ground, and then the installation of the base seat 5 is completed. Afterwards, the connection support 2 is fixed on the base seat 5 by using the base bolts 4, and the base bolt 4 is securely mounted in a symmetrical way. After the installation of the connection support 2 is completed, the reinforcement seat bracket 31 is put on the fixed supporting column 22, the anti-toppling supporting feet 32 is punched into the soil according to the position of each of the plate on the reinforcement seat bracket 31, and the anti-toppling supporting feet 32 is fixed on the reinforcement seat bracket 31 through bolt and maintains a certain tension. Finally, the frost prevention machine column 11 is put on the anti-toppling guide cylinder 21, and the anti-toppling guide cylinder 21 and the frost prevention machine column 11 are fixed by the means of plug welding.

The embodiment of the preferred embodiment of the present invention, but the present invention is not limited to the above-described embodiments, without departing from the essential elements of the invention, the field technical personnel able to make any obvious improvement, replace, or variant all belong to the scope of protection of invention.

1. A fixed support for anti-toppling frost prevention machine, the fixed support comprising a frost prevention machine, a connection support, an anti-toppling reinforcement seat, a base bolt and a base seat, wherein the connection support includes an anti-toppling guide cylinder, a fixed supporting column, and a connecting plate; the anti-toppling reinforcement seat is formed by fixing a reinforcement seat bracket and anti-toppling supporting feet through a bolt; the base seat is formed by fixing a base plate through an upper connecting ring and a lower connecting ring, further characterized in that the base bolt is used for fixing the connection support and the base seat.

2. A fixed support for anti-toppling frost prevention machine according to claim 1, wherein an outer diameter of the anti-toppling guide cylinder is 0.5 millimeters-1 millimeter smaller than an inner diameter of the fixed supporting column and an inner diameter of the frost prevention machine column, and an outer diameter of the frost prevention machine column is equal to an outer diameter of the fixed supporting column.

3. A fixed support for anti-toppling frost prevention machine according to claim 1, wherein the anti-toppling guide cylinder is installed into the fixed supporting column and the frost prevention machine column with lengths that are respectively more than 200 millimeters, and is fixed via plug welding, and plug holes are 2 or 3 groups.

4. A fixed support for anti-toppling frost prevention machine according to claim 1, wherein the anti-toppling reinforcement seat is provided with the anti-toppling supporting feet to penetrate into soil to enhance anti-dumping ability of device, and a width of the anti-toppling supporting feet is 80 millimeters-100 millimeters.

5. A fixed support for anti-toppling frost prevention machine according to claim 4, wherein an inner diameter of a central pipe of the anti-toppling reinforcement seat is 0.5 millimeters-1 millimeter larger than an outer diameter of the fixed supporting column, so as to facilitate installation of the fixed supporting column.

6. A fixed support for anti-toppling frost prevention machine according to claim 1, wherein a cross-section of the base seat is cross-shaped or Y-shaped.

7. A fixed support for anti-toppling frost prevention machine according to claim 1, wherein holes are formed on the base plate to integrate soil inside and outside of the base seat as one piece.
